(19) United States
(12) Patent Application Publication
(10) Pub. No.: US 2012/0027892 A1
(43) Pub. Date: Feb. 2, 2012

(54) JUICE BEVERAGE

(75) Inventor: Eric S. K. Leung, Blackwood, NJ (US)

(73) Assignee: S T Agri Global Inc., Blackwood, NJ (US)

(21) Appl. No.: 12/847,679

(22) Filed: Jul. 30, 2010

(51) Int. Cl. A23L 2/02; A23L 2/58; A23L 1/304; A23L 1/05; A23L 1/302; A23L 2/56; A23L 2/60

(52) U.S. Cl. 426/72; 426/599; 426/250

(57) ABSTRACT

A low-calorie beverage includes a base component derived from one or more vegetables. The base component is at least approximately 20% by weight of the low-calorie beverage on a single strength basis. The base component has a first sugar content per unit of the one or more vegetables. The low-calorie beverage also includes at least one fruit juice mixed with the base component. The at least one fruit juice is derived from a flavoring fruit and provides a fruit flavor to the beverage. The flavoring fruit provided the fruit juice with a second sugar content per unit of the flavoring fruit. The second sugar content is substantially unmodified after the at least one fruit juice is derived from the flavoring fruit. The second sugar content is greater than the first sugar content.

### FIELD OF THE INVENTION

The present invention generally relates to a beverage produced from fruits and vegetables. More specifically, the present invention relates to a beverage that combines a fruit juice with a low-sugar ingredient to produce a low calorie fruit juice beverage that does not require removal of sugar from the fruit juice used in the beverage.

### BACKGROUND OF THE INVENTION

A large selection of commercially-produced, non-alcoholic beverages is available to consumers. The selection includes, for example, sodas, juices, sports drinks, and energy drinks, and flavored and unflavored water. Taste preferences generally determine the type of beverage a consumer selects. However, consumers are also concerned about leading healthier lifestyles. Thus, demand has increased for low-calorie or diet beverages, which help consumers avoid unhealthy weight gain. In addition, demand has increased for healthy beverages that provide nutrition, such as a serving of fruits and/or vegetables. Furthermore, demand has increased for flavored water, because flavored water provides an appealing taste while appearing to have the purity of water and fewer unhealthy ingredients, such as artificial coloring.

To reduce the calories in a beverage made from fruits, beverage producers often remove the sugar that comes naturally from the fruits. For example, apple juice is high in calories due to a relatively high sugar content, so beverage producers often remove some of the sugar from the apple juice to make a low-calorie beverage. The sugar in apple juice can be reduced to approximately 8 grams of sugar per 100 grams of apples used to make the apple juice.

Government regulatory bodies may require a minimum amount of sugar content for a beverage to be considered a particular type of juice. For example, the definition of “apple juice” according to the United States Food and Drug Administration (FDA) requires 12 grams of sugar per 100 grams of apples used to make the apple juice. Thus, if the sugar has been reduced to approximately 8 grams per 100 grams of apples, the beverage producer cannot market the beverage as an “apple juice.” The beverage must be marketed, instead, as an “apple-flavored” beverage.

Moreover, government regulatory bodies may require a beverage to provide a minimum reduction in calories to be considered “low-calorie.” For example, the FDA requires that beverages reduce the number calories by at least approximately 30% to be considered “low-calorie.” (See 21 CFR 101.60(b).) Although removing the sugar may be effective in reducing the calories in a fruit juice to produce a low-calorie beverage, the removal of sugar may prevent the beverage from meeting the definition of a fruit juice and being marketed to the public as a fruit juice.

### SUMMARY OF THE INVENTION

In view of the foregoing, beverage producers require an effective approach for making a fruit juice beverage that is low-calorie while also retaining the sugar content in the fruit juice(s) used in the beverage.

Accordingly, a beverage according to the present concepts includes a base component derived from one or more vegetables. The base component is at least approximately 20% by weight of the beverage on a single strength basis. The base component has a first sugar content per unit of the one or more vegetables. The beverage also includes at least one fruit juice mixed with the base component. The at least one fruit juice is derived from a flavoring fruit and provides a fruit flavor to the beverage. The flavoring fruit provided the fruit juice with a second sugar content per unit of the flavoring fruit. The second sugar content is substantially unmodified after the at least one fruit juice is derived from the flavoring fruit. The second sugar content is greater than the first sugar content.

Additionally, a method for making a beverage according to the present concepts includes producing a base component from one or more vegetables. The base component has a first sugar content per unit of the one or more vegetables. The method also includes mixing at least one fruit juice with the base component. The at least one fruit juice is derived from a flavoring fruit and provides a flavor to the beverage. The flavoring fruit provides the at least one fruit juice with a second sugar content per unit of the flavoring fruit. The second sugar content is substantially unmodified after the at least one fruit juice is derived from the flavoring fruit. The second sugar content being greater than the first sugar content. The base component is at least approximately 20% by weight of the beverage on a single strength basis.

In embodiments according to the present concepts, the one or more vegetables of the base component include at least one of broccoli, celery, cucumber, and cabbage.

In additional embodiments, the first sugar content of the base component is approximately 1.5 grams to approximately 4 grams of sugar per unit of the one or more vegetables.

In further embodiments, the second sugar content of the at least one fruit juice is greater than approximately 8 grams of sugar per unit of flavoring fruit.

In yet further embodiments, the base component is at least approximately 20% by weight of the beverage on a single strength basis, and the beverage has less than approximately 90 calories per 240 ml.

In other embodiments, the base component is at least approximately 50% by weight of the beverage on a single strength basis, and the beverage has less than approximately 45 calories per 240 ml.

In yet other embodiments, the base component is substantially colorless on a single strength basis.

In additional embodiments, the beverage also includes at least one of: an additional sweetener, a vitamin, a mineral, a thickening agent, and a coloring agent.

These and other aspects of the present concepts will become more apparent from the following detailed description when viewed in conjunction with the accompanying drawings.

### BRIEF DESCRIPTION OF THE DRAWINGS

FIG. 1 illustrates a composition for a low-calorie fruit juice beverage according to the present concepts.

FIG. 2 illustrates a process for making a low-calorie fruit juice beverage according to the present concepts.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention.

### DETAILED DESCRIPTION OF ILLUSTRATED EMBODIMENTS

The present concepts allow a low-calorie fruit juice beverage to be produced without removing sugar from the fruit juice(s) used in the beverage. Advantageously, the composition of the fruit juice beverage allows it to be properly marketed as a fruit juice, e.g., in compliance with the regulatory definition of the relevant fruit juice(s). In addition, the composition of the fruit juice beverage allows it to be marketed as a low-calorie beverage, e.g., in compliance with the regulatory definition of a low-calorie beverage.

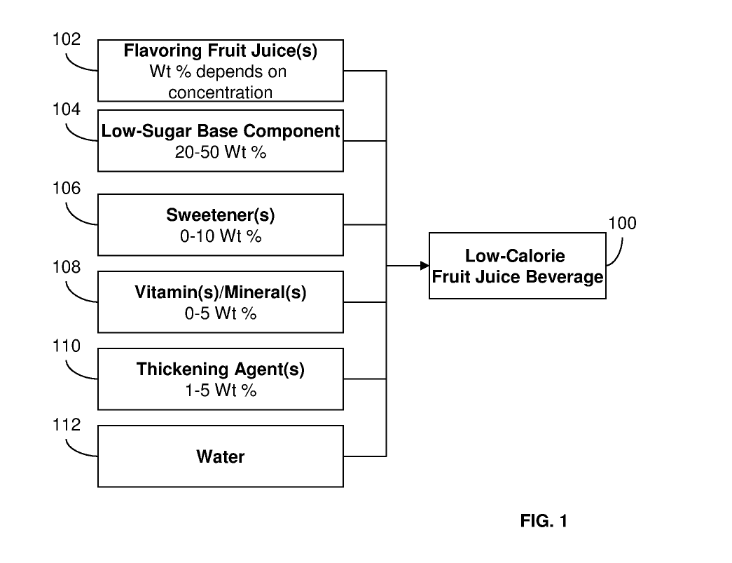

FIG. 1 illustrates an example of a low-calorie fruit juice beverage 100 made according to the present concepts. The low-calorie fruit juice beverage 100 includes one or more flavoring fruit juices 102 mixed with a base component 104. The flavoring fruit juices 102 provide the low-calorie fruit juice beverage 100 with the flavor of one or more selected fruits. The flavoring fruit juices 102 may also provide the low-calorie fruit juice beverage 100 with its appearance, e.g., color. Examples of selected fruits for the flavoring fruit juices 102 include apples, oranges, pomegranates, pineapples, peaches, mangoes, bananas, strawberries, and the like. For instance, flavoring fruit juices 102 made from oranges and pineapples provide the low-calorie fruit juice beverage 100 with a combination of orange and pineapple flavors. The weight percentage of flavoring fruit juices 102 in the low-calorie fruit juice beverage 100 depends on the desired mixture of fruit flavors, the desired strength of each fruit flavor, the concentration of the flavoring fruit juices 102, the desired caloric content of the low-calorie fruit juice beverage 100, etc.

The flavoring fruit juices 102 may have a sugar content that provides more calories than desired for the final low-calorie fruit juice beverage 100. Rather than removing the sugar from the flavoring fruit juices 102 to reduce the number of calories in the low-calorie fruit juice beverage 100, the flavoring fruit juices 102 are mixed with the low-sugar base component 104 to dilute the sugar content from the flavoring fruit juices 102. In other words, due to the presence of the low-sugar base component 104, the sugar content and correspondingly the number of calories in the final low-calorie fruit juice beverage 100 is lower than a beverage that primarily contains the flavoring fruit juices 102. The weight percentage of the low-sugar base component 104 in the low-calorie fruit juice beverage 100 may range from approximately 20% to approximately 50%.

Because the flavoring fruit juices 102 retain the sugar content from their fruits and sugar is not removed from the flavoring fruit juices 102, the final low-calorie fruit juice beverage 100 may be considered a fruit juice according to the FDA definition. Furthermore, because the sugar content of the final low-calorie fruit juice beverage 100 can be reduced by mixing in the low-sugar base component 104, the low-calorie fruit juice beverage 100 may be considered a low-calorie beverage according to the FDA definition (21 CFR 101.60(b)).

The low-sugar base component 104 may be produced from a combination of low-sugar vegetables. In particular, the base component 104 may be produced from vegetables that are mild in flavor, so that the base component does not significantly modify the flavor from the flavoring fruit juices 102. In addition, the low-sugar base component 104 may be substantially neutral in appearance, e.g., colorless, on a single strength basis, so that it does not have a significant effect on the appearance of the final low-calorie fruit juice beverage 100. Vegetables that are mild in flavor and that yield a substantially colorless juice include cabbage, broccoli, cucumber, and celery, and the like. Such vegetables may have a relatively lower sugar content, because they have a relatively higher water content.

For example, a low-calorie apple juice beverage may be produced by mixing an apple juice, i.e., a high-sugar flavoring fruit juice made from applies or apple concentrate, with a cucumber juice, i.e., a low-sugar base component. The cucumber juice does not significantly modify the flavor of the apple juice and does not significantly affect the appearance of the final low-calorie fruit juice beverage. Apple juice contains approximately 12 grams of sugar per 100 grams of apples used to make the apple juice, while the cucumber juice contains approximately 1.5 grams to approximately 4 grams of sugar per 100 grams of cucumber used to make the cucumber juice. The resulting combination of apple juice and cucumber juice may, for example, contain approximately 8 grams of sugar per 100 grams of apple and cucumber used.

When the base component 104 is produced from a combination of low-sugar vegetables, the low-calorie fruit juice beverage 100 also provides a nutritious serving of fruits and vegetables. In general, low-calorie fruit juice beverages produced according to the present concepts meet consumer demands for beverages that have fewer calories and provide a nutritious serving of fruits and vegetables, while providing the taste of a fruit juice. Although embodiments described herein may employ a single base component, it is understood that some low-calorie fruit juice beverages contemplated herein may contain more than one base component. In addition, although embodiments described herein may employ low-sugar vegetables, it is understood that other ingredients, such as low-sugar fruits, may be used to produce the low-sugar base component.

Because the base component 104 may be mild in flavor and neutral in appearance, the base component 104 may be mixed with any number and combination of flavoring fruit juices 102 to produce a variety of low-calorie fruit juice beverages 100. In other words, the base component 104 may be a common ingredient for a large variety of low-calorie fruit juice beverages 100. A different base component 104 does not have to be specially produced for each flavor of low-calorie fruit juice beverage 100. For example, a base component 104 produced from cucumbers may be mixed with apple juice to make an apple juice beverage, and the same base component 104 may be mixed with orange and pineapple juices to make an orange-pineapple juice beverage.

Using the same base component 104 to produce a variety of low-calorie fruit juice beverages 100 offers production efficiencies and cost savings. Indeed, a separate dedicated facility or outside supplier may be responsible for producing and delivering the base component 104, and a final production facility may be responsible for making and packaging the final low-calorie fruit juice beverage by blending the base component 104 with flavoring fruit juices 102.

As shown further in FIG. 1, the low-calorie fruit juice beverage 100 may include additional, optional ingredients, such as sweetener(s) 106, supplemental vitamin(s) and/or mineral(s) 108, and thickening agent(s) 110. Water 112 constitutes the balance of the final low-calorie fruit juice beverage 100. Other optional ingredients may include coloring(s) and other natural or artificial flavoring(s).

The sweetener(s) 106 may include natural and/or artificial sweeteners. The weight percentage of natural sweeteners in the low-calorie fruit juice beverage 100 does not exceed approximately 10%. Artificial sweeteners, for example, may include aspartame, saccharin, sucralose, or the like. The weight percentage of artificial sweeteners in the low-calorie fruit juice beverage 100 does not exceed approximately 3%. In general, the overall weight percentage of sweetener(s) in the low-calorie fruit juice beverage 100 ranges from approximately 0% to approximately 10%. To produce a low-calorie, natural fruit juice beverage, however, it is preferable that the low-calorie fruit juice beverage 100 include no additional sweeteners.

The supplemental vitamin(s) and/or mineral(s) 108 increase the health benefits of the low-calorie fruit juice beverage 100. The weight percentage of the supplemental vitamin(s) and/or mineral(s) 108 in the low-calorie fruit juice beverage 100 ranges from approximately 0% to approximately 5%.

The thickening agent(s) 110, for example, may include pectin. The weight percentage of the thickening agent(s) 110 in the low-calorie fruit juice beverage 100 ranges from approximately 0% to approximately 1.5%.

In some embodiments, the low-calorie fruit juice beverage 100 has the taste and appearance of a conventional fruit juice. In particular, the low-calorie fruit juice beverage 100 includes a blend of fruit(s) and vegetable(s) that constitutes at least a weight percentage of 20% on a single strength, i.e., unconcentrated, basis for the low-calorie fruit juice beverage 100. For these embodiments, the Brix content of the low-calorie fruit juice beverage 100 is at most 90 calories per 240 ml serving.

In other embodiments, the low-calorie fruit juice beverage 100 is a juice water that has a visual appearance similar to natural water, i.e., colorless. In particular, an optical measurement of the juice water at a wavelength of 625 nm is not less than approximately 90%, and an optical measurement of the juice water at a wavelength of 410 nm is not more than approximately 10%. The juice water includes a blend of fruits and vegetables that constitutes at least a weight percentage of 50% (on a single strength basis) for the juice water. For these embodiments, the Brix content of the juice water is at most 45 calories per 240 ml serving. As described previously, demand has increased for flavored water, because flavored water provides an appealing taste while appearing to have the purity of water and fewer unhealthy ingredients, such as artificial coloring. Advantageously, the juice water provides a low-calorie flavored water with a nutritious serving of fruit(s) and vegetable(s).

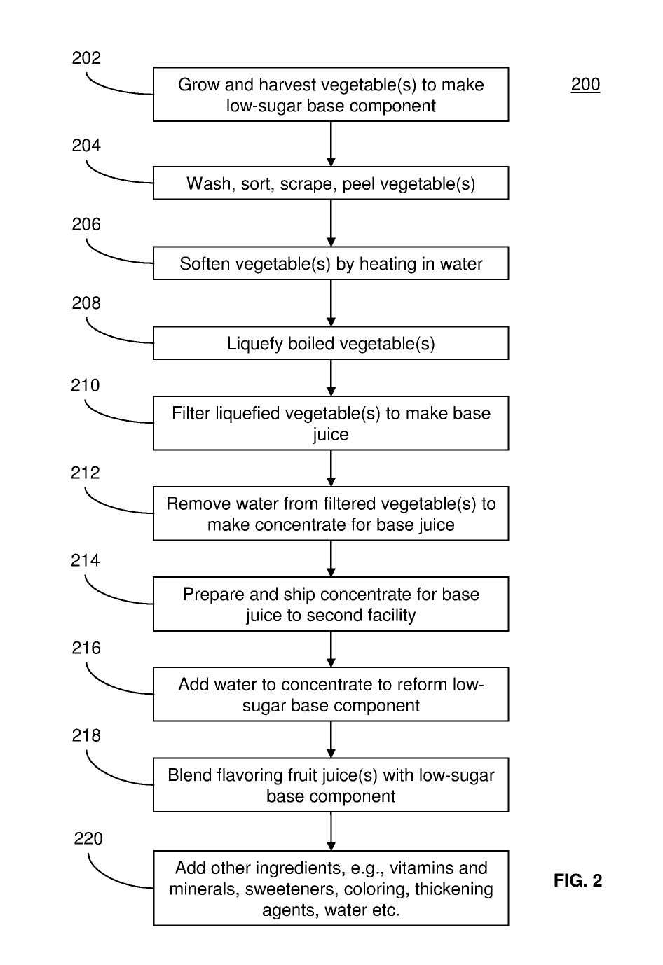

FIG. 2 illustrates a process 200 for making a low-calorie fruit juice beverage according to aspects of the present concepts. In an initial step 202, selected types of vegetables are grown and harvested to make a low-sugar base component. As described above, the vegetables in step 202 are mild in flavor, so that the base component does not significantly modify the flavor of the low-calorie fruit juice beverage. In addition, the base component may be substantially neutral in appearance, so that it does not have a significant effect on the appearance of the low-calorie fruit juice beverage. The base component may be derived from cabbage, broccoli, cucumber, celery, and the like, or any combination thereof. However, as described above, other ingredients, such as low-sugar fruits, may be used to produce the low-sugar base component.

As shown further in FIG. 2, the harvested vegetables are then washed, sorted, scraped, and/or peeled in step 204. After the processing of step 204, the vegetables are softened in step 206 by heating or boiling the vegetables in water. For example, the vegetables may be heated at temperatures in the range of approximately 45° C. to approximately 135° C. for approximately 5 minutes to approximately 45 minutes. The amount of time for the heating may depend on the condition, e.g., ripeness, of the vegetables. Riper vegetables generally require less time to soften. Before the vegetables are heated in step 206, they may also be crushed with water, e.g., soft water, in a temperature range of approximately 15° C. to approximately 95° C. The water to vegetable ratio during this crushing step ranges from approximately 0.5:1 to approximately 50 to 1. The particle size of the vegetables after this crushing step may be at most approximately 1 cubic inch.

The vegetables are sufficiently softened in step 206 to facilitate the process of liquefying the vegetables in step 208. In particular, the vegetables are further crushed or squeezed in a squeezer to liquefy the vegetables.

During step 208, the liquefied vegetables may be treated so that the liquid has a pH in the range of approximately 2 to approximately 6. For example, absorbic acid (vitamin C) may be added to the liquefied vegetables to adjust the pH. The weight percentage of the added absorbic acid may range from approximately 0.05% to approximately 5%.

In addition, during step 208, the liquefied vegetables may be treated with an enzyme to adjust the viscosity of the liquid and facilitate subsequent filtering in step 210. For example, pectin is substantially removed from the liquefied vegetables by adsorption and the subsequent filtering. The liquefied vegetables may be treated for approximately 1 hour to approximately 3 hours depending on the desired viscosity.

Furthermore, although some vegetables, such as cucumber, may naturally produce a substantially colorless base component, embodiments may treat the liquefied vegetables to decolorize the liquefied vegetables further. For example, the liquefied vegetables may be decolorized and absorbed by active carbon or decolorization resin for approximately 1 hour to approximately 3 hours.

In step 210, the liquefied vegetables are ultra-filtered several times to remove solid or semi-solid materials from the liquefied vegetables. In some cases, steps 206, 208, and 210 may be performed for each sorted vegetable and the resulting vegetable juices may be subsequently combined. In addition, the temperature and the timing of the steps in the process are controlled to maintain freshness of the base component and to achieve the mild flavor of the base component.

As described previously, a separate dedicated facility or outside supplier may be responsible for producing and delivering the base component. As such, shipment of the base component to another production facility may be required for further processing, packaging, distribution, etc. In this case, water may be removed from the base component in step 212 to make a concentrate. For example, a desired amount of water may be evaporated from the base component in a vacuum evaporator. Shipping and storing the base component in the form of a concentrate provides cost savings, because it weighs less and is more compact. The base component may be concentrated to a level that is at least approximately 20 to 25 times the strength of the base component before the water is removed, i.e., its single strength. It is understood that the concentration level is not limited to these example values. A concentration strength of less than 20, however, may require the unnecessary shipment of water as a component of the juice. The soluble solid content of the concentrated base component may be approximately 10% to approximately 70%.

During step 214, the concentrated base component may be cooled to below approximately 90° C., filtered, and bottled. The filtration, for example, is accomplished using a bergmeal or other suitable filter. The concentrated base component may then be stored and shipped at a temperature of approximately −30° C. to approximately 25° C.

Once the concentrate is shipped and is ready for continued processing, water is added in step 216 to the concentrate to reform the base component at its single strength. In some cases, the base component is not shipped or shipping costs may be insignificant, so steps 212, 214, and 216 may be omitted.

As shown further in FIG. 2, the base component is mixed with at least one flavoring fruit juice in step 218 to provide flavoring and color for the low-calorie fruit juice beverage. In some embodiments, the flavoring fruit juice is separately produced and provided by a supplier as a concentrated puree. Water may be added to bring the flavoring fruit juice to single strength. As described previously, the flavoring fruit juice in step 218, for example, may be derived from apples, oranges, pomegranates, pineapples, peaches, mangoes, bananas, strawberries, and the like. The flavoring fruit juice retains the sugar content of the fruits from which it is derived. Although the flavoring fruit juices may generally be high in sugar, the sugar content is diluted when the flavoring fruit juices are mixed with the base component, yielding a low-calorie fruit juice beverage with a low-sugar content. Thus, the final low-calorie fruit juice beverage may be marketed as a low-calorie beverage containing fruit juice.

Other ingredients may be to added in step 220 before the final low-calorie fruit juice beverage is packaged and sold. These additional ingredients may include water, supplemental vitamins and minerals, natural sweeteners or artificial sweeteners (e.g., aspartame), coloring, other natural and artificial flavoring, and thickening agents (e.g., pectin). In general, step 220 allows the low-calorie fruit juice beverage to be modified for its final taste and other organoleptic properties. Although the low-calorie fruit juice beverage may contain vegetable juices, it does not have a vegetable after-taste, due to the mild flavor of the vegetables employed.

Accordingly, low-calorie fruit juice beverages produced according to the present concepts provide beverages that have fewer calories and provide a nutritious serving of fruits and vegetables while providing the taste of a fruit juice without an undesirable vegetable after-taste. In particular, embodiments may employ a low-sugar base component derived from a mild-flavored vegetable, which allows a low-calorie fruit juice beverage to maintain the defined characteristics of a fruit juice while reducing its calories and enriching it with serving(s) of vegetable.

While various embodiments in accordance with the present concepts have been shown and described, it is understood that the invention is not limited thereto. The present concepts may be changed, modified and further applied by those skilled in the art. Therefore, this invention is not limited to the detail shown and described previously, but also includes all such changes and modifications.

What is claimed is:

1. A beverage, comprising:
a base component derived from one or more vegetables, the base component being at least approximately 20% by weight of the beverage on a single strength basis, the base component having a first sugar content per unit of the one or more vegetables; and
at least one fruit juice mixed with the base component, the at least one fruit juice being derived from a flavoring fruit and providing a fruit flavor to the beverage, the flavoring fruit providing the fruit juice with a second sugar content per unit of the flavoring fruit, the second sugar content being substantially unmodified after the at least one fruit juice is derived from the flavoring fruit, the second sugar content being greater than the first sugar content.

2. The beverage of claim 1, wherein the one or more vegetables include at least one of broccoli, celery, cucumber, and cabbage.

3. The beverage of claim 1, wherein first sugar content is approximately 1.5 grams to approximately 4 grams of sugar per unit of the one or more vegetables.

4. The beverage of claim 1, wherein the second sugar content is greater than approximately 8 grams of sugar per unit of flavoring fruit.

5. The beverage of claim 1, wherein the base component is at least approximately 20% by weight of the beverage on a single strength basis, and the beverage has less than approximately 90 calories per 240 ml.

6. The beverage of claim 1, wherein the base component is at least approximately 50% by weight of the beverage on a single strength basis, and the beverage has less than approximately 45 calories per 240 ml.

7. The beverage of claim 1, wherein the base component is substantially colorless on a single strength basis.

8. The beverage of claim 1, further comprising at least one of: an additional sweetener, a vitamin, a mineral, a thickening agent, and a coloring agent.

9. A method for making a beverage, comprising:
producing a base component from one or more vegetables, the base component having a first sugar content per unit of the one or more vegetables; and
mixing at least one fruit juice with the base component, the at least one fruit juice being derived from a flavoring fruit and providing a flavor to the beverage, the flavoring fruit providing the at least one fruit juice with a second sugar content per unit of the flavoring fruit, the second sugar content being substantially unmodified after the at least one fruit juice is derived from the flavoring fruit, the second sugar content being greater than the first sugar content,
wherein the base component is at least approximately 20% by weight of the beverage on a single strength basis.

10. The method of claim 9, wherein the one or more vegetables include at least one of broccoli, celery, cucumber, and cabbage.

11. The method of claim 9, wherein first sugar content is approximately 1.5 grams to approximately 4 grams of sugar per unit of the one or more vegetables.

12. The method of claim 9, wherein the second sugar content is greater than approximately 8 grams of sugar per unit of the flavoring fruit.

13. The method of claim 9, wherein the base component is at least approximately 20% by weight of the beverage on a single strength basis, and the beverage has less than approximately 90 calories per 240 ml.

14. The method of claim 9, wherein the base component is at least approximately 50% by weight of the beverage on a single strength basis, and the beverage has less than approximately 45 calories per 240 ml.

15. The method of claim 9, wherein the base component is substantially colorless on a single strength basis.

16. The method of claim 9, further comprising mixing the base component and the at least one fruit juice with at least one of: an additional sweetener, a vitamin, a mineral, a thickening agent, and a coloring agent.

17. The method of claim 9, further comprising selecting the at least one fruit juice from a variety of fruit juices, each of the variety of fruit juices being mixable with the base component to make a type of beverage.
